(19) United States
(12) Patent Application Publication
(10) Pub. No.: US 2002/0188542 A1
(43) Pub. Date: Dec. 12, 2002

(54) Compensation-data processing

(76) Inventors: Yong Zhang, Needham, MA (US); William H. Coleman, Boston, MA (US); Gregory K. Plunkett, Boston, MA (US); Andrew I. Linn, Waltham, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/121,147

(22) Filed: Apr. 11, 2002

Related U.S. Application Data
(60) Provisional application No. 60/283,878, filed on Apr. 13, 2001.

(51) Int. Cl. G06F 17/60

(52) U.S. Cl. 705/36

(57) ABSTRACT

A computer program product resides on a computer-readable medium and includes computer-readable and computer-executable instructions for causing a computer to access a compensation-data storage device, retrieve compensation data from the compensation-data storage device, the compensation data including information regarding job title and pay of individuals of a first business entity associated with the compensation-data storage device, and transmit the retrieved compensation data toward a processing system via a wide-area communications network, the processing system being associated with a second business entity that is different from the first business entity, where the computer-executable instructions are configured to cause the computer to at least one of access, retrieve, and attempt to transmit the compensation data automatically.

### CROSS-REFERENCE TO RELATED APPLICATIONS

This application claims the benefit of U.S. Provisional Application No. 60/283,878 filed Apr. 13, 2001.

### FIELD OF THE INVENTION

The invention relates to processing compensation data and in particular, to processing compensation data stored according to different data models.

### BACKGROUND OF THE INVENTION

Companies exist that collect, analyze and report employee compensation-related data for use by a company's human resources department and/or other managers as well as third party consultants, recruiters, etc. Compensation-related data includes a person's total compensation. A person's total compensation includes components such as base pay, cash incentives, commissions, overtime, long term incentives, stock options, restricted stock, stock appreciation rights, phantom stock, performance shares, performance units, profit sharing, 401(k) contributions, 403(b) contributions, Sec 125 contributions, health and welfare plan contributions, pension contributions, perquisites, supplemental executive plan contributions, paid time off (vacation, sick time, holidays, personal days, etc.) and other compensation or benefits payments.

One known method for using compensation data involves collecting data from thousands of companies each year and producing a number of summary reports of that data. Participating companies are asked to provide certain basic corporate data and employee compensation-related data in a preformatted diskette. This request is time-specific and typically occurs once per year (occasionally two or four times per year for select groups). An individual at each participating company responsible for data entry collects all relevant data from multiple locations within the organization and puts the data onto the diskette. The diskette is used by a compensation-data processing company to update a database on or before a pre-set cutoff date. When sufficient data has been loaded into the database, analysis is conducted and reports are prepared for distribution. Data may be distributed online as opposed to distribution by “hard products” such as a diskette or paper reports.

Another known method for using compensation data provides for online entry of data where the data entry is preformatted to the data format of the company collecting the data. Each time data are requested by the data collecting company, one or more individuals at the participating company collect individual employee data, typically from multiple databases, merge these data and enter them according to the format of the data collecting company.

### SUMMARY OF THE INVENTION

In general, in an aspect, the invention provides a computer program product residing on a computer-readable medium and including computer-readable and computer-executable instructions for causing a computer to access a compensation-data storage device, retrieve compensation data from the compensation-data storage device, the compensation data including information regarding job title and pay of individuals of a first business entity associated with the compensation-data storage device, and transmit the retrieved compensation data toward a processing system via a wide-area communications network, the processing system being associated with a second business entity that is different from the first business entity, where the computer-executable instructions are configured to cause the computer to at least one of access, retrieve, and attempt to transmit the compensation data automatically.

Implementations of the invention may include one or more of the following features. The computer program product further includes mapping instructions for causing the computer to map the retrieved compensation data from a first model associated with the compensation-data storage device of the first business entity to a second model associated with the processing system of the second business entity. The mapping instructions are configured to cause the computer to map first job titles of the first model to second job titles of the second model. The mapping instructions are configured to cause the computer to map first compensation components of the first model to second compensation components of the second model.

Implementations of the invention may also include one or more of the following features. The computer-executable instructions are configured to cause the computer to access, retrieve, and attempt to transmit the compensation data automatically. The event is at least one of expiration of a counter and occurrence of a predetermined time. The computer-executable instructions are configured to cause the computer to at least one of access, retrieve, and attempt to transmit the compensation data in response to a manual command. The manual command is initiated at one of the first and the second business entities.

In general, in another aspect, the invention provides a computer program product residing on a computer-readable medium and including computer-readable and computer-executable instructions for causing a computer to automatically request, via a telecommunications network, compensation data to be sent via the telecommunications network from a compensation-data storage device, gather and analyze the compensation data including determining statistics related to the compensation data, and store the analyzed compensation data in a data-exchange storage device.

Implementations of the invention may include one or more of the following features. The computer program product further includes instructions for causing the computer to transmit the analyzed data via the telecommunications network toward a recipient device. The computer program product further includes instructions for causing the computer to transmit instructions for causing the recipient device to arrange the analyzed data in a graphical report for viewing by a user of the recipient device. The instructions for causing the computer to gather and analyze comprise instructions for causing the computer to map the analyzed data from a data-exchange format associated with the data-exchange storage device to a second format associated with the recipient device. The instructions for causing the computer to gather and analyze comprise instructions for causing the computer to map the compensation data from a data-exchange format associated with the data-exchange storage device to a second format associated with a recipient device. The instructions for causing the computer to gather and analyze comprise instructions for causing the computer to aggregate the compensation data associated with multiple business entities. The computer program product further includes instructions for causing the computer to store compensation data, associated with each of multiple business entities, in the data-exchange storage device.

In general, in another aspect, the invention provides a method of processing compensation data from a plurality of business entities, the method including automatically initiating collection of first compensation data from a plurality of storage devices associated with the plurality of business entities, obtaining, via a wide-area telecommunications network, second compensation data indicative of the collected first compensation data, the second compensation data being in accordance with a predetermined standard compensation-data model, the model including salary and job title information, analyzing the second compensation data to determine statistics related to the collected data, and transmitting, via the packet-switched network, display indicia to a second plurality of business entities to display the analyzed data using display apparatus.

Implementations of the invention may include one or more of the following features. The obtaining includes translating the first compensation data from a first compensation-data model into the second compensation data having the predetermined standard compensation-data model. The obtaining includes transmitting the first compensation data via the wide-area network. The obtaining includes transmitting the second compensation data via the wide-area network. The translating includes calling a software routine from a computer associated with the first compensation data. The translating includes downloading the software routine, via the wide-area network, to the computer associated with the first compensation data. The method further includes delivering third compensation data indicative of the first compensation data to the recipient device, the third compensation data being in accordance with a recipient-device compensation-data model.

Implementations of the invention may also include one or more of the following features. Information indicative of the first compensation data is transmitted via the wide-area network in response to at least one of a predetermined amount of time passing since a prior such transmission, the passing of a predetermined time, and actuation of a computer associated with the first compensation data. The display indicia are of a protocol readable by a variety of platforms.

Various aspects of the invention may provide one or more of the following advantages. Compensation data can be extracted, aggregated, analyzed, and reports produced and conveyed in near real time. Compensation data can be collected from different business entities using different compensation-data models and process quickly using a standardized data model. The collection of data can occur periodically or aperiodically and quickly using computers. Compensation data can be reported aperiodically, e.g., upon demand by a collection company, or periodically, and can be done automatically, or in response to manual commands, e.g., from a collecting company or a reporting company. Compensation data can be collected and processed throughout the year, and can be provided at any time. Composite, processed compensation data from many entities can be obtained by a reporting company throughout the year either periodically or aperiodically in response to requests by the company desiring to see the data. Compensation data can be collected from multiple locations within a company reporting its compensation data. Such compensation data can be reported without combining the data. Information can be obtained from different sources, e.g., internal and external to a company whose compensation information is reported, processed, etc., and at different times.

These and other advantages of the invention, along with the invention itself, will be more fully understood after a review of the following figures, detailed description, and claims.

### BRIEF DESCRIPTION OF THE FIGURES

FIG. 1 is a schematic diagram of a compensation reporting and processing system.

FIG. 2 are tables of compensation data models used by a reporting section and a processing section of the system shown in FIG. 1.

FIG. 3 is a block diagram of interaction of processing layers of the system shown in FIG.

FIG. 4 is a simplified diagram of the system shown in FIG. 1 illustrating multiple reporting business entities.

FIG. 5 is a block flow diagram flow diagram of a process of collecting, compiling, and reporting compensation data using the system shown in FIG. 1.

### DETAILED DESCRIPTION OF PREFERRED EMBODIMENTS

The invention provides techniques for reporting and obtaining compensation data. The compensation data can be reported aperiodically, e.g., upon demand by a collection company, or periodically, and can be done automatically, or in response to manual commands. The reporting can be initiated by a person at the company whose information is reported, or transparently. Compensation data can be collected throughout the year, and can be provided at any time. Distributed data can thus reflect current, or very recent, activity in a given market. Data can be obtained by a company throughout the year either periodically or aperiodically in response to requests by the company desiring to see the data.

Embodiments of the invention are directed to a network system that includes one or more Compensation Data Exchange Modules (CDEMs) that translate between data models/structures of one or more databases and a data model of a central compensation data exchange database via a network. The central compensation data exchange database collects and analyzes the data and makes the analyzed data available for distribution. Embodiments of the invention may be used with various types of data such as employee compensation data, survey data, employment data, census data, data exchanged between a corporation and its subsidiaries.

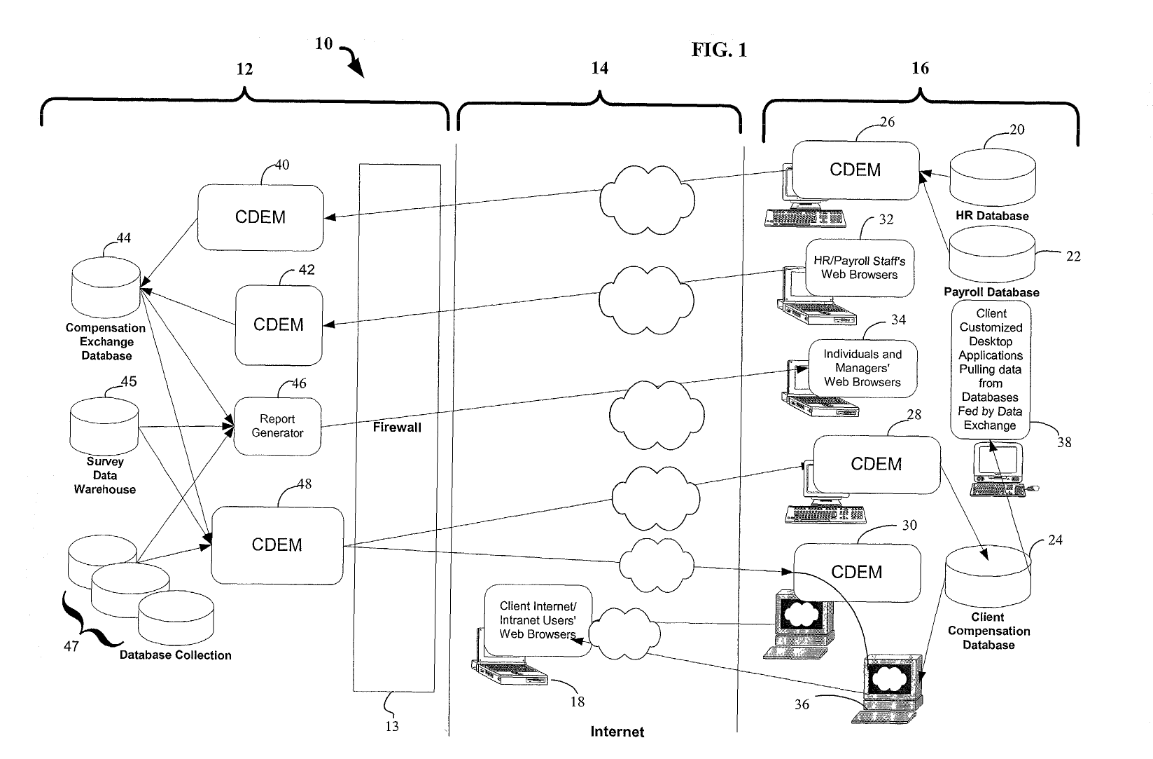

Referring to FIG. 1, a system 10 for reporting, collecting, analyzing and distributing compensation and compensation-related data (collectively referred to as compensation data) includes a data processing section 12, a data transfer section 14, and a data reporting section 16. The processing section 12 is a service-providing company for collecting, analyzing, and distributing compensation data. The transfer section 14 includes one or more data transmission media and protocols, such as packet-switched telecommunication networks including the global packet-switched network known as the Internet, for conveying data between the processing section 12 and the reporting section 16. The transfer section 14 may also include computers, or other devices capable of communicating with portions of the reporting section 16, such as a computer 18 configured with network browsing software for communicating via the Internet with the reporting section 16. The reporting section 16 includes multiple business entities that report their compensation data for processing by the processing section. The reporting section includes devices for accumulating, storing, accessing, and reporting compensation data via the transfer section 14 to the processing section 12.

The reporting section 16 includes a human resources (HR) database 20, a payroll database 22, a client compensation database 24, compensation data exchange modules (CDEMs) 26, 28, 30, an HR/payroll staff's web browser 32, an individual/manager web browser 34, a web site/application server 36, and a client desktop applications unit 38. The individual/manager browser 34, the web site/application server 36, the applications unit 38, the client compensation database 24, and the CDEMs 28, 30 are configured and arranged for manipulating information from the processing section 12, and are discussed below after the discussion of the processing section 12. The HR database 20, the payroll database 22, the CDEM 26, and the HR/payroll web browser 32 are configured and arranged to supply information to the processing section 12.

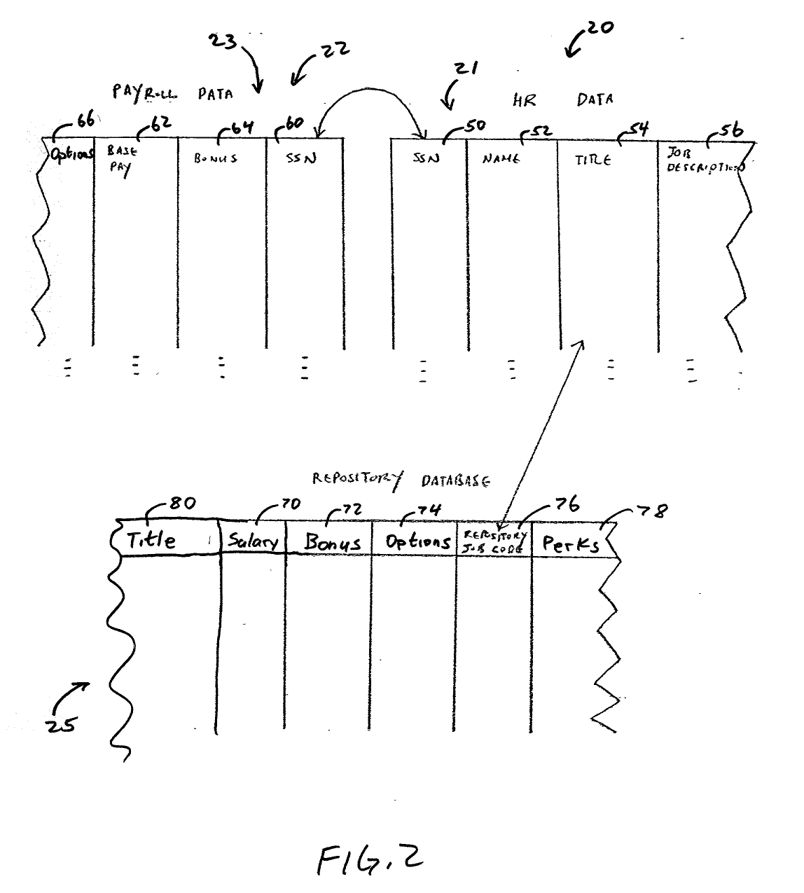

Referring also to FIG. 2, the HR database 20 and the payroll database 22 are computer-readable media that store information regarding employees, including compensation of the employees. The HR database 20 stores information identifying employees and what they do. This information includes employees' social security numbers (and/or other identifying codes such as employee number) 50, names 52, job title 54 as assigned by the employees' company, and a job description 56 outlining duties of the employees. The payroll database 22 stores information identifying employees and what forms of compensation they receive and in what amounts. This payroll data includes data fields with identifying information such as the employees' social security numbers 60, and compensation data including base pay 62, bonus pay 64, options (such as stock options) 64, and any other forms of compensation applicable (such as health benefits). Fewer or more payroll data fields may be provided in the database 22 depending upon the company. Some of the payroll data fields will be empty, or have null values, depending upon the employee, e.g., with low-level employees typically not having stock options or bonuses as part of their compensation.

The CDEM 26 is configured as a software module running on a computer. The CDEM 26 is a software module that includes Application Program Interface (API) calls, and comprises computer-executable code, stored on a computer-readable medium, that is executable by a processor associated with the software (e.g., the processor can access and read the medium on which the software is stored). The computer-readable medium may be memory such as Read-Only Memory (ROM), Random-Access Memory (RAM), flash memory, carrier signals, or combinations of any of these. Due to the nature of software, the CDEM 26 could be implemented using hardware (e.g., an Application-Specific Integrated Circuit (ASIC)), firmware, hardwiring, or software, or combinations of any of these. Further, the CDEM 26 could be distributed throughout the system 10, and may be part of the same device as the HR database 20 and/or the payroll database 22 (e.g., if one or both of these databases 20, 22 are parts of the medium associated with the CDEM 26).

Referring also to FIG. 2, the CDEM 26 is configured to access and read information from the HR and payroll databases 20, 22, and to translate the data models 21, 23 of the data stored in these databases 20, 22 into a data model 25 used by the processing section 12. In particular, the CDEM 26 can perform data mapping that includes data field (compensation component) mapping and job title/entity mapping.

For field mapping, the CDEM 26 is configured to read the fields in the payroll database 22 and process these payroll fields in accordance with compensation fields, and definitions of those fields, used by the processing section 12, and in particular a central compensation data exchange database 44. For example, the CDEM 26 may translate data from the base pay field 62 into data of a salary field 70, the bonus field 64 into a bonus field 72, and the options field 66 into an options field 74. The CDEM 26 may also manipulate data, e.g., by accumulating data from multiple fields in the payroll database 22, such as company car, meal allowance, etc., and determining a total amount that is applied to a perks field 78 in the central database 44. The manipulating may include summing the individual payroll database fields, and discounting the sum by some amount (e.g., representative of a difference between actual cash outlay and worth to the employee) to achieve the result to be put in the perks field 78.

For job title/entity mapping, the CDEM 26 is configured to read the data in the job title field 54 in the HR database 20 and translate these data into standard job titles 80 used by the processing section 12, and stored in the central compensation data exchange database 40 with the compensation data. The CDEM 26 translates the HR database title 54 into the standard title 80 in accordance with mapping determined by the company whose data are being reported by the CDEM 26 to the processing section, and/or by the processing section 12 (e.g., an employee in the processing section 12). For example, a job title 54 of “Senior Accountant” at a company in the reporting section 16 may be mapped to a job title 80 of “Accountant II” for the processing section 12. The title mapping is determined by comparing job descriptions 56 and corresponding titles 54 of the reporting company with job descriptions and corresponding titles used by the processing section 12. To develop the title mapping, other data may be used, e.g., pay, bonus, options, etc., instead of or in addition to the job descriptions. Entity mapping is developed similarly using data related to entities such as any part of the company that collects/reports itself, subsidiaries, divisions, parents, divisions, reporting groups, departments, etc. of a company in the reporting company in section 16 and standard descriptions used in the processing section 12.

The CDEM 26 reports unmapped and mapped data to the CDEM 40 of the processing section 12 periodically or upon demand. The CDEM 26 is configured to automatically transfer or attempt to transfer data to the CDEM 40 via the transfer section 14 on a periodic basis. An attempt to transfer could include queuing data and querying a user whether to send the queued data, or querying the user as to whether to transfer the data, and transferring the data in response to an indication to do so. A data transfer can be initiated using the CDEM 40 or through the CDEM 26 on a manual basis at any desired time. The CDEM 40 can receive unmapped data from the CDEM 26 and perform the mapping to the model/format of the central compensation data exchange database 44. Alternatively, the CDEM 40 can receive some mapped data and some unmapped data and perform the mapping on the unmapped data.

The HR/payroll staff's web browser 32 of the reporting section 16 is configured to provide generic job title/entity mapping data to the processing section 12. While the CDEM 26 provides specific data related to particular persons that may or may not be mapped to the format of the processing section 12, the HR/payroll web browser 32 provides data that are more generic. For example, the browser 32 provides data regarding a person's education, background including prior work experience, years of experience (e.g., in general and in the current line of work), and pay level. The browser thus provides data for the processing section 12 to use to map/relate generic qualities to job titles and/or job classes. The web browser 32 can also provide information mapping the generic information to categories used by the processing section 12 such as job title and/or job class. The browser 32 can also provide information regarding related entities (e.g., parents, subsidiaries), location of entities (including itself), number of subsidiaries, vertical entity information (e.g., where in the organization of parents and subsidiaries a company lies), etc.

The processing section includes CDEMs 40, 42, a central compensation data exchange database 44, a survey data warehouse 45, a report generator 46, a database collection 47, and another CDEM 48. The CDEMS 40, 42 and the database 44 are configured for receiving HR and payroll data, mapping data as appropriate to a processing-section data format, and storing processing-section-formatted HR and payroll data. The database 44, the data warehouse 45, and the database collection 47 are configured to store and supply data to the report generator 46 and the CDEM 48. The report generator 46 and the CDEM 48 are configured to process and supply data to the reporting section 16, and in particular the CDEMs 28, 30.

The CDEMs 40, 42 are configured to receive and process, as appropriate, data from the CDEM 26 and the HR/payroll web browser 32, respectively, of the reporting section 16. The CDEM 40 can determine whether the data received from the CDEM 26 has been mapped into the processing-section format 25 and, if not, perform the mapping as described above with respect to the CDEM 26. Processor-section-formatted data are sent by the CDEM 40 to the central database 44 for storage and further processing. The CDEM 42 likewise determines whether the generic data received from the browser 32 has been mapped to the processor-section format and, if not, maps the generic data to the processor-section format 25. These data are sent by the CDEM 42 to the central database 44 for storage and further processing.

Mapping by any CDEM, e.g., CDEM 26, 40, or 42, can be set up initially, and then not altered upon data after the initial setup unless the mapping has changed. For example, job title mapping will typically not change often; once the mapping from a company's job titles to the job titles of the processing section 12 is configured, this same mapping can be applied unless the company's or the processing section's job titles change, e.g., in either number of titles, names of titles, or definition of titles. Also, job title mapping may be bypassed, if a person's job title changes to a job title for which a prior mapping exists. The job titles typically do not frequently change, and thus the job title mapping will typically not change. Thus, when a company whose job title mapping has been setup previously, then the job title mapping need not be configured again, and is preferably reconfigured only if there is an indication provided by the company or the processing section that a change in one or more of the job titles has occurred since the prior job title mapping configuration. Similarly, for compensation component mapping, the mapping of compensation component fields (e.g., base pay 62 to salary 70; FIG. 2) will change infrequently, although the data occupying fields will change often (e.g., due to annual base pay adjustments, promotions, etc.). The mapping of the field data for a particular person need not be redone if no changes in the data have occurred since the last data collection for that person. Thus, the CDEM 26 can bypass accessing, retrieving, and/or transmitting data regarding a particular person if the data for that person has not changed since the last transmission of that person's data. Any field or group of fields, whether associated with one person, multiple persons, etc., can be bypassed in this way. An indication is provided to the processing section for each field, person, group of persons, etc., for which prior data stored in the database 44 should be used. Preferably, for a person (or other entity associated with a set of fields) whose field data has been transmitted to the processing section 12, only field data that have changed are accessed, retrieved, and transmitted to the processing section 12.

The central compensation data exchange database 44 is configured to store processor-section-formatted data, and to process these data to provide meaningful compilations of data. The database 44 stores data in records that may be associated with each other as desired. For example, records of individuals having the same processing-section job title may be stored together, or may be accessed for processing by searching the job title fields 80 of the stored records. The central database 44 resides on a server with multiple loadable modules that can operate on the stored data to, e.g., aggregate and analyze the data. For example, a loadable module of the server 44 can determine statistics for the various job titles. Statistics include averages, medians, maxima, and minima of base salary, bonuses, and options. Data can be aggregated for different geographic areas, and can be weighted to account for different costs of living in different regions. Additionally, another loadable module can aggregate data based on a customer's vertical information (e.g., parents, subsidiaries, industry categories etc.). The analyzed/aggregated data can be stored in further records or storage locations for retrieval and processing by the report generator 46 and the CDEM 48. Loadable modules can be developed/added to analyze/aggregate data in other ways as appropriate (e.g., as new desires arise).

Other sources of data for the report generator 46 and the CDEM 48 are the survey data warehouse 45 and the database collection 47. Data included in the warehouse 45 are traditional data collected through, e.g., industry surveys such as paper surveys filled out by companies and input into the warehouse 45. Preferably these data are correlated, e.g., according to one or more categories such as job title and salary. The database collection 47 preferably includes a job board data warehouse and other databases and data warehouses, although fewer data collections are acceptable. Data in the database collection 47 are preferably also arranged into correlated categories to facilitate report production and use by persons or other entities in the reporting section 16. Data in the collection 47 includes data from job boards and other job listings that provide sufficient information to provide meaningful additions to the foundation of data used by the processing section to formulate job statistics.

The report generator 46 is connected to the central compensation data exchange database 44, the survey data warehouse 45, and the database collection 47, and is configured to format data into various reports. The report generator 46 can selectively retrieve data from the data storage devices 44, 45, 47 and aggregate and arrange the retrieved data into predetermined formats designed to assist analysis of, and/or understanding of, the stored data. An exemplary report includes average salary for a selected job title in different part of the United States, with the salary being adjusted for cost-of-living differences. Another exemplary report will reflect typical qualifications (e.g., education and years of experience) for one or more job titles. The report generator aggregates the appropriate data, formats these data, and produces instructions for displaying the data in a user-friendly way, e.g., on a graphical user interface (GUI). The report generator can send the instructions for displaying the data to the reporting section 16 via the transfer section 14. In particular, the generator 46 can send the instructions to the individual/manager web browser 34. The browser 34 is configured to display the data in accordance with the instructions received from the report generator 46. A user of the browser 34 can review and/or manipulate the displayed data.

The CDEM 48, either by itself or in conjunction with the CDEMs 28, 30 of the reporting section 16, translate/map the data stored in the storage devices 44, 45, 47 from the processing-section format 25 (FIG. 2) to the reporting section format 21, 23 (FIG. 2). This mapping includes mapping the job title 80 to the job title 54 and converting the compensation data, e.g., salary 70, bonus 72, and options 74 into appropriate fields for the reporting section 16, e.g., base pay 62, bonus 64, and options 66. The CDEM 48 operates as a distributor of the data stored in the storage devices 44, 45, 47.

The CDEMs 28, 30 are configured to transfer the data received from the CDEM 48, and mapped into the appropriate format, to the client compensation database 24 for storage and retrieval by other devices, and to the computer 18 for retrieval and analysis/manipulation. The computer 18 can include a web browser for accessing the compensation data from the CDEM 30 for a user of the computer 18 to analyze, absorb, understand, manipulate, or otherwise process the compensation data. Preferably, the CDEM 30 provides the compensation data for the computer 18 in real time upon receipt of the data from the CDEM 48. The client database 24 stores the data received from the CDEM 28 in records organized and/or correlated to facilitate retrieval and use by the client desktop applications unit 38 and the web site/application server 36. The web site/application server 36 is configured to process the data stored in the database 24 and to provide the processed data to the computer 18. The applications unit 38 includes customized desktop applications configured to pull data from the database 24 and process the pulled data for presentation to users of the unit 38.

Data can be delivered using a variety of techniques (e.g., pull and push, active and passive) using the system 10. For example, data may be accessed by a module built around the CDEM 28, 30, e.g., URL-based API (application program interface) calls in the module. Unified API calls can be used across platforms (e.g., operating systems, back-end data and network systems), web servers, and programming languages and are easy to understand, not requiring developers to have back-end knowledge of the platforms or web servers. COM components and JAVA packages can be used that wrap URL-based API calls, are easy to implement into customized web, desktop, and console applications. Further, Windows® and JAVA applications can be used as pre-built data transfer applications by using CDEM modules and associated layers.

Compensation data can be reported, mapped, stored, forwarded, transmitted to receiving parties, and displayed by receiving parties in a variety of ways. For example, in addition to the ways described above, the CDEM 40 could map, as appropriate, data from the CDEM 26 and send the data (as mapped by the CDEM 26 or the CDEM 40) to, e.g., the CDEM 48 or the report generator 46, bypassing the database 44. In this way, or by the report generator 46 or the CDEM 48 extracting raw, non-aggregated compensation data from database as stored by the CDEMs 40, 42, the processing section 12 can, e.g., transmit raw, non-aggregated, compensation data from one company to another company (e.g., in the same line of business). These raw data will have been mapped from the one company's compensation data format/model to the other company's compensation data format/model.

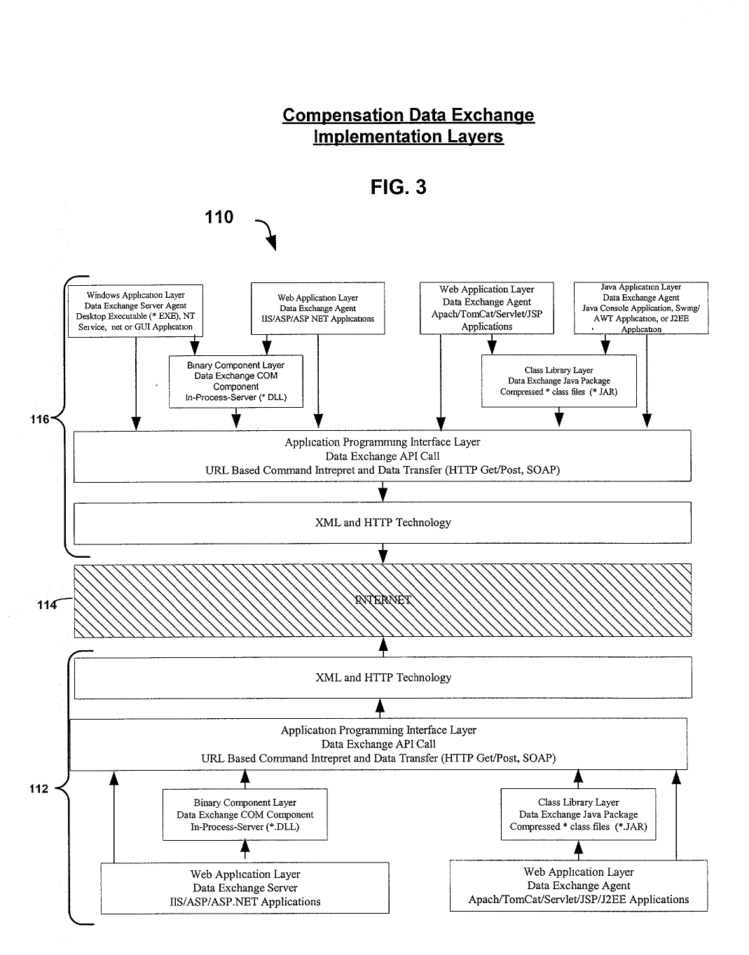

Referring to FIGS. 1 and 3, the system 10 of FIG. 1 is shown in FIG. 3 as a system 110 of implementation layers. The system 110 includes a processing section 112, a transfer section 114 (here the Internet), and a reporting section 116. The CDEMs 26, 28, 30, 40, 42, 48 encompass a full range of implementation layers, and can be distributed at desired layers. A CDEM can be at a lower-level layer, in which case the customer can customize the CDEM significantly by coding the CDEM. Alternatively, a CDEM can be provided at a high-level layer, in which case the CDEM is essentially a turnkey program, but inhibits coding by the customer and thus is less flexible than a lower-level layer CDEM.

The CDEMs 26, 28, 30, 40, 42, 48 are configured to facilitate communication between different resource platforms. Each CDEM 26, 28, 30, 40, 42, 48 includes tools that can read and write from different databases or other apparatus that use different platforms. The CDEMs 26, 28, 30, 40, 42, 48 use Uniform Resource Locator based (URL-based) Application Program Interface (API) calls to interact with databases such that the same call can be used for different platforms. URL-based API calls can be implemented using the HyperText Transfer Protocol (HTTP), a meta-language, or a markup language such as HyperText Markup Language (HTML) or eXtensible Markup Language (XML). For example, a CDEM in the reporting section 116 can transfer data using XML and HTTP through the Internet 114 a destination web server, application server, or database server. The application receiving the data can convert the XML data into a format compatible with the receiving application. CDEMs in the processing section 112 are similarly-configured, and thus can provide bi-directional communication with the reporting section independent of platforms used be each section 112, 116.

The CDEMs 26, 28, 30, 40, 42, 48 and customized applications built around the CDEMs 26, 28, 30, 40, 42, 48 can be easily configured as function calls, e.g., as simply as a single line of software code. For example, a CDEM in the reporting section 116 can be a single-line function call to a server in the processing section 112. The call can be a URL-based call, such that any language used by the reporting section 116 can make the call to the processing section 112 and the processing section 112 will be able to interpret the call, and provide the requested functionality. The call can initiate communication between the CDEMs and the software built around the CDEMs.

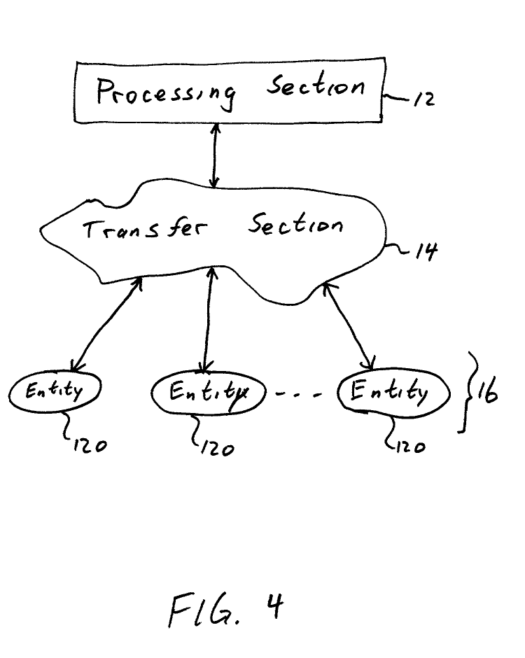

Referring to FIGS. 1 and 4, the reporting section 16 of the system 10 includes many business entities 120. The entities 120 can be distributed in different geographic locations, e.g., within a country or around the world. With many different entities 120, there will be many different data models that are mapped differently into the model used by the processing section 12. The mapping of data to/from the processing section 12 from/to the entities will depend on the entities. Data may be manipulated by the processing section 12 differently depending upon the business entity to receive data from the processing section 12. For example, the processing section may put reports into different protocols depending upon the receiving business entity 120, or may send reports using a protocol, e.g., XML, that is readable by many, if not all, the business entities 120. Further, data sent from different entities 120 include identifiers of the entities 120 sending the particular information and/or indications of a location and/or region associated with the entities, e.g., the cities where the entities reside.

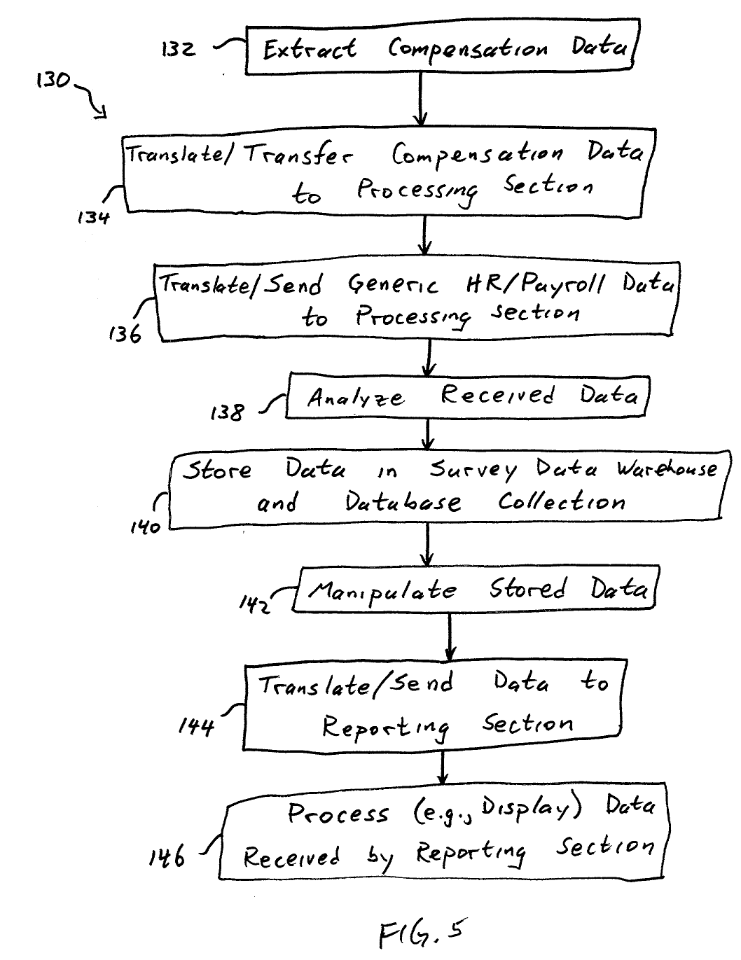

In operation, referring to FIG. 5, with further reference to FIGS. 1-2, a process 130 for collecting, compiling, and reporting compensation data using the system 10 includes the stages shown. The process 130, however, is exemplary only and not limiting. The process 130 can be altered, e.g., by having stages added, removed, or rearranged.

At stage 132, compensation data are extracted from the HR database 20 and payroll database 22. The data can be accessed and extracted in response to several events occurring. For example, a manual request can be made using a computer implementing the CDEM 26. Also, the accessing and extraction can be initiated/performed automatically, e.g., by this same computer in response to, e.g., the reaching of a predetermined value of a counter (e.g., the timing out or expiration of a timer that was initiated upon a previous data extraction and that is reinitiated upon this extraction), the occurrence of a time (i.e., a historical time such as 8:00 AM Wednesday, or a specific date), or in response to a user action other than a specific request (e.g., logging on or turning on the computer or responding to an inquiry whether to extract the data). The extraction can also be in response to a combination of events, such as the user logging on after a timer has expired or after a specific time of a specific date has passed. Additionally, extraction (and/or transfer as discussed with respect to stage 134) may be performed only if data, e.g., compensation component data, or job titles, in fields of the person or persons for whom data are to be extracted, have changed since a prior extraction, if any. Otherwise, indicia are provided that data for a particular person or persons for whom no data have changed, the data may be retrieved from the database 44.

At stage 134, compensation data from the databases 20, 22 are transmitted from the reporting section 16 via the transfer section, here the Internet, 14 to the processing section and mapped from a model of the reporting section 16 to a model of the processing section 12. The transmission can be done automatically for data that have been manually or automatically extracted. Either or both of the CDEMs 26, 40 can map/translate the compensation data from the databases 20, 22 to the data model used by the processing section 12. Thus, all of the translating may be done in either CDEM 26, 40, or some in both. The CDEM 26 may be implemented by an API call by the computer implementing the CDEM 26 to the processing section 12. In response, a computer software code routine, such as a JAVA code (e.g., applet), is returned and executed by the computer in the reporting section 16. The translated/mapped data are sent to the central compensation data exchange database 44 for storage and further processing.

At stage 136, data are sent from the HR/Payroll web browser 32 to the processing section 12 via the transfer section 14 and mapped as appropriate. These data include relatively-generic data concerning compensation such as education, background experience, and pay level associated with the given education and experience descriptions/criteria. The CDEM 42 in the processing section 12 maps the received generic data as appropriate for the data model of the database 44, and transmits the mapped data to the database 44 for storage and further processing.

At stage 138, the central compensation data exchange database 44 analyzes the received data from multiple CDEMs 26 associated with multiple business entities. The data exchange database 44 determines statistics regarding the stored data, such as sums, averages, medians, maxima, and minima of salaries for various job titles and/or geographic regions. The statistics are determined by the data exchange database 44 by appropriate weightings, e.g., to compensate for cost-of-living differences. As mentioned above, stages may be removed from the process 130, including stage 138, e.g., if raw compensation data are transferred from one company to another, having been mapped to the receiving company's data model, but without analysis or aggregation with other companies' data. These data may be stored in the database 44 and forwarded to the receiving company, or forwarded without having been stored.

At stage 140, data are stored in the survey data warehouse 45 and the database collection 47. Data are stored in the devices 45, 47 using computers to input information received, e.g., from surveys or gleaned from job postings.

At stage 142, data from the storage devices 44, 45, 47 are manipulated by the report generator 46 into report formats for users in the reporting section 16. The data may be extracted by the report generator 46 and massaged into report format, or the data may be compiled by the data exchange database 44 and extracted by the report generator 46 and inserted into one or more reports. The report generator 46 sends report data as desired to appropriate business entities (e.g., entities that have requested and/or paid for specific reports, or all reports, available from the report generator 46). The reports are preferably sent using URL-based transmissions or using other protocols that are widely available or at least amenable to being read and used by a variety of platforms.

At stage 144, the CDEM 48 pulls data from the data storage devices 44, 45, 47 as appropriate and transmits the data via the transfer section 14 to CDEMs 28, 30. Data translation may occur in any of the CDEMs 48, 28, 30 as appropriate to arrange the data pulled from the devices 44, 45, 47 in one or more desired formats for use by the reporting section 16.

At stage 146, data received from the processing section 12 by the reporting section 16 is processed as appropriate. The CDEM 28 supplies data from the processing section 12 to the database 24 for use by the desktop applications unit 38. Data from the database 24 can be processed by the web site/application server 36 and sent to the computer 18. Data from the processing section 12 are also sent to the computer 18 by the CDEM 30.

Using the system 10, data can be extracted, aggregated, analyzed, and reports produced and conveyed in near real time. The collection of data can occur periodically and quickly using computers. The collection can be comprehensive, e.g., of all business entities from which data can be collected using the system 10, or selective, e.g., of subsets of the entities. Subsets of entities can be varied such that data from all the entities are collected, e.g., within a given period such as every six months. Data collection time can be reduced by collecting only data that have changed since a prior collection. Using computers in the processing section 12, the collected compensation data can be quickly processed and rapidly turned around to interested business entities.

Other embodiments are within the scope and spirit of the appended claims. For example, while CDEMS were described as extracting data from resource databases, the CDEMs can be used to extract data from other sources, e.g., spreadsheets, flat files, XML files, or other applications used for data. CDEMs can also feed data, in addition to extracting data, between a source and a database. Further, multiple databases described as separate databases can be implemented as a single database, e.g., HR database 20 and payroll database 22 could be implemented as a single database. Further, compensation data for a company may be reported by a third party that is not part of the company whose compensation data are reported, processed, etc. For example, a third-party company may be part of the reporting section 12 and may collect and report another company's compensation data to the processing section 12 via the transfer section 14.

What is claimed is:

1. A computer program product residing on a computer-readable medium and comprising computer-readable and computer-executable instructions for causing a computer to:
access a compensation-data storage device;
retrieve compensation data from the compensation-data storage device, the compensation data including information regarding job title and pay of individuals of a first business entity associated with the compensation-data storage device; and
transmit the retrieved compensation data toward a processing system via a wide-area communications network, the processing system being associated with a second business entity that is different from the first business entity;
wherein the computer-executable instructions are configured to cause the computer to at least one of access, retrieve, and attempt to transmit the compensation data automatically.

2. The computer program product of claim 1 further comprising mapping instructions for causing the computer to map the retrieved compensation data from a first model associated with the compensation-data storage device of the first business entity to a second model associated with the processing system of the second business entity.

3. The computer program product of claim 2 wherein the mapping instructions are configured to cause the computer to map first job titles of the first model to second job titles of the second model.

4. The computer program product of claim 2 wherein the mapping instructions are configured to cause the computer to map first compensation components of the first model to second compensation components of the second model.

5. The computer program product of claim 1 wherein the computer-executable instructions are configured to cause the computer to access, retrieve, and attempt to transmit the compensation data automatically.

6. The computer program product of claim 5 wherein the event is at least one of expiration of a counter and occurrence of a predetermined time.

7. The computer program product of claim 5 wherein the computer-executable instructions are configured to cause the computer to at least one of access, retrieve, and attempt to transmit the compensation data in response to a manual command.

8. The computer program product of claim 5 wherein the manual command is initiated at one of the first and the second business entities.

9. A computer program product residing on a computer-readable medium and comprising computer-readable and computer-executable instructions for causing a computer to:
automatically request, via a telecommunications network, compensation data to be sent via the telecommunications network from a compensation-data storage device;
gather and analyze the compensation data including determining statistics related to the compensation data; and
store the analyzed compensation data in a data-exchange storage device.

10. The computer program product of claim 9 further comprising instructions for causing the computer to transmit the analyzed data via the telecommunications network toward a recipient device.

11. The computer program product of claim 10 further comprising instructions for causing the computer to transmit instructions for causing the recipient device to arrange the analyzed data in a graphical report for viewing by a user of the recipient device.

12. The computer program product of claim 10 wherein the instructions for causing the computer to gather and analyze comprise instructions for causing the computer to map the analyzed data from a data-exchange format associated with the data-exchange storage device to a second format associated with the recipient device.

13. The computer program product of claim 9 wherein the instructions for causing the computer to gather and analyze comprise instructions for causing the computer to map the compensation data from a data-exchange format associated with the data-exchange storage device to a second format associated with a recipient device.

14. The computer program product of claim 9 wherein the instructions for causing the computer to gather and analyze comprise instructions for causing the computer to aggregate the compensation data associated with multiple business entities.

15. The computer program product of claim 9 further comprising instructions for causing the computer to store compensation data, associated with each of multiple business entities, in the data-exchange storage device.

16. A method of processing compensation data from a plurality of business entities, the method comprising:
automatically initiating collection of first compensation data from a plurality of storage devices associated with the plurality of business entities;
obtaining, via a wide-area telecommunications network, second compensation data indicative of the collected first compensation data, the second compensation data being in accordance with a predetermined standard compensation-data model, the model including salary and job title information;
analyzing the second compensation data to determine statistics related to the collected data; and
transmitting, via the packet-switched network, display indicia to a second plurality of business entities to display the analyzed data using display apparatus.

17. The method of claim 16 wherein the obtaining includes translating the first compensation data from a first compensation-data model into the second compensation data having the predetermined standard compensation-data model.

18. The method of claim 17 wherein the obtaining includes transmitting the first compensation data via the wide-area network.

19. The method of claim 17 wherein the obtaining includes transmitting the second compensation data via the wide-area network.

20. The method of claim 17 wherein the translating includes calling a software routine from a computer associated with the first compensation data.

21. The method of claim 20 wherein the translating includes downloading the software routine, via the wide-area network, to the computer associated with the first compensation data.

22. The method of claim 17 further comprising delivering third compensation data indicative of the first compensation data to the recipient device, the third compensation data being in accordance with a recipient-device compensation-data model.

23. The method of claim 16 wherein information indicative of the first compensation data is transmitted via the wide-area network in response to at least one of a predetermined amount of time passing since a prior such transmission, the passing of a predetermined time, and actuation of a computer associated with the first compensation data.

24. The method of claim 16 wherein the display indicia are of a protocol readable by a variety of platforms.

25. The method of claim 24 wherein the display indicia are URL-based.
